(19) United States
(12) Patent Application Publication
(10) Pub. No.: US 2026/0062226 A1
(43) Pub. Date: Mar. 5, 2026

(54) SYSTEM AND METHOD FOR ARRANGING BUNDLES INTO A PATTERN AND SIMULATING A LAYER FORMING OPERATION

(71) Applicant: A. G. Stacker Inc., Weyers Cave, VA (US)

(72) Inventors: Randall Donn SENGER, Mount Sidney, VA (US); Jerry BLOSSER, Crimora, VA (US); Joseph WUNDER, Lexington, VA (US)

(21) Appl. No.: 19/314,883

(22) Filed: Aug. 29, 2025

Related U.S. Application Data
(60) Provisional application No. 63/689,012, filed on Aug. 30, 2024.

(51) Int. Cl. B65G 43/08; B65G 47/244; B65G 57/11; G05B 17/02

(52) U.S. Cl. CPC B65G 43/08; B65G 47/244; B65G 57/11; G05B 17/02

(57) ABSTRACT

A method includes defining a configuration of physical bundles on a physical support surface, providing a bundle computer model of at least one of the physical bundles and providing a conveyor computer model of a physical conveyor. The physical conveyor is a conveyor configured to carry the physical bundles from an upstream end of the physical conveyor to a downstream end and to deposit the physical bundles on the physical support surface. The physical conveyor includes a controller and at least one adjustment section configured to adjust a position and/or orientation of the physical bundles. Also using a processor running the conveyor computer model to automatically determine from the conveyor computer model and the bundle computer model a control data set including instructions for causing the controller to operate the physical conveyor to produce the configuration of the given number of the physical bundles on the physical support surface.

### CROSS-REFERENCE TO RELATED APPLICATIONS

The present application claims the benefit of U.S. provisional patent application No. 63/689,012, filed Aug. 30, 2024, the entire contents of which are hereby incorporated by reference.

### TECHNOLOGICAL FIELD

The present disclosure is directed to a method and system for causing a computer model of a conveyor system to automatically produce a desired pattern of bundle models on a support surface and to produce a control data set to cause a physical conveyor to create the same pattern of physical bundles on the support surface.

### BACKGROUND

Corrugated paperboard may be processed to create blanks that can be folded and assembled into finished products such as boxes and other packaging material. Various process steps occur from the time that blanks are cut from a web of corrugated material by a cutting device, such as a rotary die cut (RDC) machine, to the time that a pallet supporting hundreds or thousands of these blanks, arranged in stacks of bundles, leaves a manufacturing facility.

These steps include using an RDC machine to cut individual lengths of interconnected blanks from an initial web and forming these lengths of blanks into stacks using a stacker. The stacks of interconnected blanks are sometimes referred to as “logs,” and the logs are further processed by a device that breaks individual sections off the logs. Each broken-off section comprises a stack of individual blanks, and the stacks may be referred to as “bundles.” The bundles are then transported to a device called a load former that has a platform on which a human operator or a robotic arm arranges the bundles in a desired pattern. The platform can be retracted to drop the layer of bundles onto on a pallet supported by a lift table (or onto a previously formed layer of bundles on the pallet), and the lift table can be lowered so that the platform can be reextended to receive another layer. When a desired number of layers of bundles have been formed on the pallet, some of which layers may be separated by tie sheets and/or include a load tag identifying the characteristics of or destination for the blanks on the pallet, the pallet is transported away from the load former for optional wrapping and storage and shipment.

Some of these steps can be automated to a greater degree than others. However, it has heretofore been somewhat difficult to automate the process of placing bundles in a desired pattern on a load former.

### SUMMARY

This problem and others are addressed by aspects of the present application.

According to aspects of the present disclosure, rather than using a worker or a robotic arm to form a pattern of bundles on a platform of a load former, the conveyor system that delivers the bundles to the load former, or a staging location near the load former, is used to shift and/or rotate the bundles on the conveyor so that they arrive at a staging location for the load former already formed into a desired pattern. Conveyor sections are known that can change the orientation and/or lateral position of an object supported by the conveyor, and by a suitable combination of rotation and shifting, a given number of bundles having a desired arrangement can be provided.

However, it is time consuming to determine exactly how each bundle should be rotated and/or positioned transversely on a conveyor to cause the conveyor to form a desired pattern or footprint. Furthermore, different layers of a stack of bundles may have different patterns of bundles. And new calculations are required every time the size and/or shape of the bundles being processed and/or the footprint of the bundle stack changes.

It is therefore an aspect of the present disclosure to provide a method and system for computer modeling a process of using a conveyor to form desired patterns of bundles, which method automatically determines the shifts and/or rotations required for each bundle to produce the required pattern, based on a known initial position of the bundles, for example, at an input or upstream end of a given conveyor section. The method and system also produces a control data set that can be output to a physical conveyor system to cause the physical conveyor system to produce the same patterns of bundles at the load former or a staging area upstream of the load former based on the desired final pattern, the configuration of the conveyor, and an initial configuration of the bundles arriving at an input or upstream end of a given conveyor section.

Another aspect of the present disclosure comprises a method that includes defining a configuration of a given number of physical bundles on a physical support surface, providing a bundle computer model of at least one of the given number of physical bundles and providing a conveyor computer model of a physical conveyor. The physical conveyor is a conveyor configured to carry the physical bundles one or more at a time from an upstream end of the physical conveyor to a downstream end of the physical conveyor and to deposit the physical bundles on the physical support surface. The physical conveyor includes a controller and at least one adjustment section configured to adjust a position and/or orientation of the physical bundles. The method also includes using a processor running the conveyor computer model to automatically determine from the conveyor computer model and the bundle computer model a control data set including instructions for causing the controller to operate the physical conveyor to produce the configuration of the given number of the physical bundles on the physical support surface.

A further aspect of the disclosure is a device including a computer processor that is configured to: store a definition of a configuration of a given number of physical bundles on a physical support surface, store a bundle computer model of each of the given number of physical bundles and store a conveyor computer model of a physical conveyor. The physical conveyor is a conveyor configured to carry the given number of physical bundles from an upstream end of the physical conveyor to a downstream end of the physical conveyor and to deposit the physical bundles on the physical support surface. The physical conveyor includes a controller and at least one adjustment section configured to adjust a position and/or orientation of the physical bundles. The processor is also configured to use the conveyor computer model to automatically determine from the conveyor computer model and the bundle computer model a control data set including instructions for causing the controller to operate the physical conveyor to produce the configuration of the given number of the physical bundles on the physical support surface.

### BRIEF DESCRIPTION OF THE DRAWINGS

These and other aspects of the disclosure will be better understood after a reading of the following detailed description of an embodiment of the disclosure together with the attached drawings in which:

FIG. 1 is a computer display showing a representation of a physical support on which a plurality of bundles of sheets can be arranged and stacked, the screen also depicting a data box for defining a thickness of the sheets and a number of sheets in a bundle.

FIG. 2 is a computer display of the physical support of FIG. 1 and a data box depicting options for importing or establishing a definition of a first layer of a stack of bundles.

FIG. 3 is s computer display of first and second layers of bundles stacked on the physical support of FIG. 1 and a data box depicting options for importing or establishing a definition of the second layer of a stack of bundles.

FIG. 4 is computer display of first, second and third layers of bundles on a stack and a data box depicting options for editing the configuration of the second layer after the third layer was added to the stack shown on the display.

FIG. 5 is a computer display showing four bundles arriving at a corner table of a conveyor system, the corner table being located at the upstream end of an adjustment conveyor section, and showing a data box depicting options for adjusting a spacing between rows of bundles and a time between the arrivals of sequential rows of bundles at the corner table.

FIG. 6 is a computer display showing four bundles arriving at the corner table of FIG. 5 and those same four bundles arranged in a desired configuration on the physical support structure.

FIG. 7 is a computer display depicting a rotation of a bundle on the adjustment section of the conveyor followed by a lateral shifting of the bundle so that the bundle will arrive at a desired position on the representation of a physical support structure.

FIG. 8 is a computer display illustrating a potential path to be followed by the second bundle of FIG. 6, which potential path will result in a collision between the second bundle and the first bundle already in place on the representation of the physical support.

FIG. 9 is a computer display illustrating a revised potential path to be followed by the second bundle of FIG. 8 to avoid a collision with the first bundle already in place on the representation of the physical support.

FIG. 10 is a computer display depicting three bundles in position on a representation of a physical support and a fourth bundle following an appropriate path to form a desired pattern of bundles on the representation of the physical support.

FIGS. 11A-11F are plan views of various sheets that can be described by a computer bundle model.

FIG. 12 is a plan view of a particular layer of bundles that can be formed by moving pairs of the bundles simultaneously along the adjustment section of the conveyor.

FIG. 13 is a block diagram of a computer system running a conveyor model and a bundle model which computer system is connected to the display and to a controller of the conveyor system.

### DETAILED DESCRIPTION

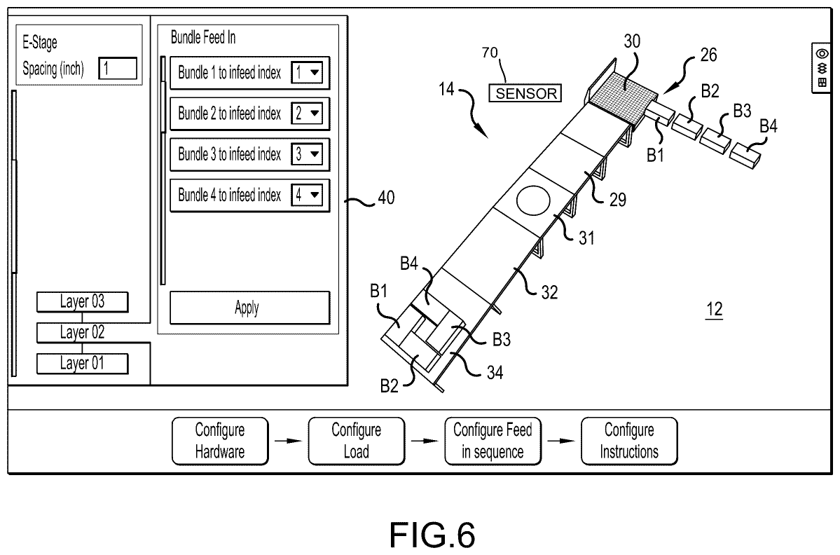

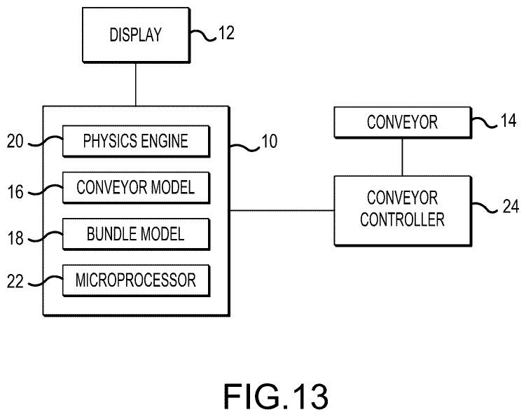

Referring now to the drawings, in which the showings are for purposes of illustrating a presently preferred embodiment of the invention only and not for the purpose of limiting same, FIG. 13 schematically illustrates a computer system 10 connected to a display 12 for displaying a virtual representation of a physical conveyor system, such as the conveyor system 14 shown in FIG. 6, and physical bundles supported and moved by the conveyor system 14. The virtual representation may be sufficiently detailed so as to constitute a digital twin of the existing conveyor system 14. However, for purposes of the disclosure, it may be acceptable to represent the conveyor system 14 in a more abstract manner as long as the movement of the bundles B along the conveyor system 14 and the positions and/or orientations of each of the bundles B can be accurately represented.

The computer system 10 stores a computer conveyor model 16 of the physical conveyor system 14 and a computer bundle model 18 of the bundles B. The computer system 10 also stores a physics engine 20, and the conveyor model 16 and bundle model 18 are used by a microprocessor 22 running the physics engine 20 to create an animation of the conveyor system 14 in operation carrying bundles B from an upstream end to a downstream end. The physics engine 20 may be a Unity physics engine which typically operates in a control system, preferably PC based, to achieve maximum functionality available, that operates at a higher level than the machine-level PLCs normally used to control industrial equipment.

The computer system 10 allows a user, while viewing an animation of the bundles B moving along portions of the conveyor system 14, to stop the animation and adjust locations and/or movements of the bundles B, such as their lateral and/or rotational positions and/or spacing and to adjust various aspects of their travel paths and/or final locations. The computer system 10 also automatically determines what movements of the bundles B are required to create a desired pattern of bundles B based an initial location of the bundles. The computer system 10 is further configured to produce a control data set that can be output to a conveyor controller 24 (such as a PLC) of the physical conveyor system 14 to cause the physical conveyor system 14 to move physical bundles B in the manner shown in by the computer conveyor model 16.

With reference to FIG. 6, the conveyor system 14 includes an input location 26 at which bundles B arrive for further processing. While the bundles B will generally arrive at the input location 26 on a conveyor (not illustrated) they could alternately arrive at the input location 26 by being placed there by a human or robotic operator. For purposes of this disclosure it will be assumed that the bundles B arrive at the input location 26 via a non-illustrated conveyor.

The conveyor system 14 includes a corner conveyor 30 configured to receive the incoming bundles B at the input location 26, an intermediate conveyor section 29, a rotating conveyor section 31, and a shifting conveyor section 32 that outputs bundles onto a physical staging platform 34. The staging platform 34 is an example of a “physical support surface” as that phrase is used herein. Furthermore, movement of bundles from the corner conveyor 30 toward the staging platform 34 will be referred to as movement in a “downstream” direction, and movement perpendicular to the downstream direction in the plane of the conveyor upper surface may be referred to as “transverse” movement.

An example of a process flow for configuring layers of a stack of bundles B using the computer system 10 is described below.

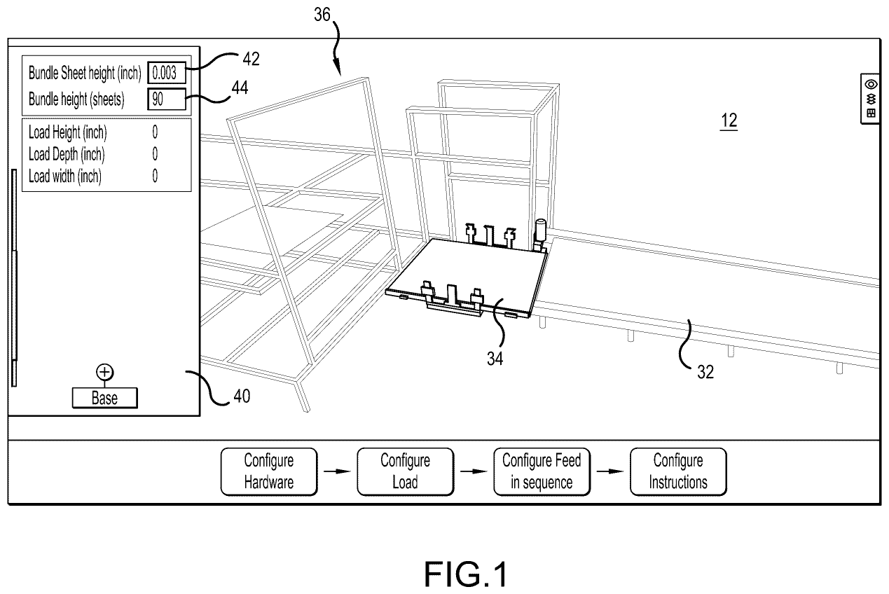

FIG. 1 shows the display 12 depicting a menu box 40 and an image of the shifting conveyor section 32 of the conveyor system 14 immediately upstream from the staging platform 34. Part of a load former 36 that will receive a layer of bundles B from the staging platform 34 is also shown.

A two-dimensional definition of a footprint of a stack of bundles B to be formed on the staging platform can be defined by user-provided data describing the sheets that make up the bundle and by using the menu 40. For example, the user can input a thickness of each sheet of a bundle in the data field 42 and the number of sheets in a bundle in the data field 44 to enable the computer system 10 running the conveyor model 16 to generate an image of a resulting bundle B. The bundles B can then be copied, shifted and/or rotated to form a desired arrangement for a first layer L1 of a stack of bundles B. The bundle arrangement, including any required spacing between bundles B of a layer L can be defined and depicted in the conveyor model 16 at this time.

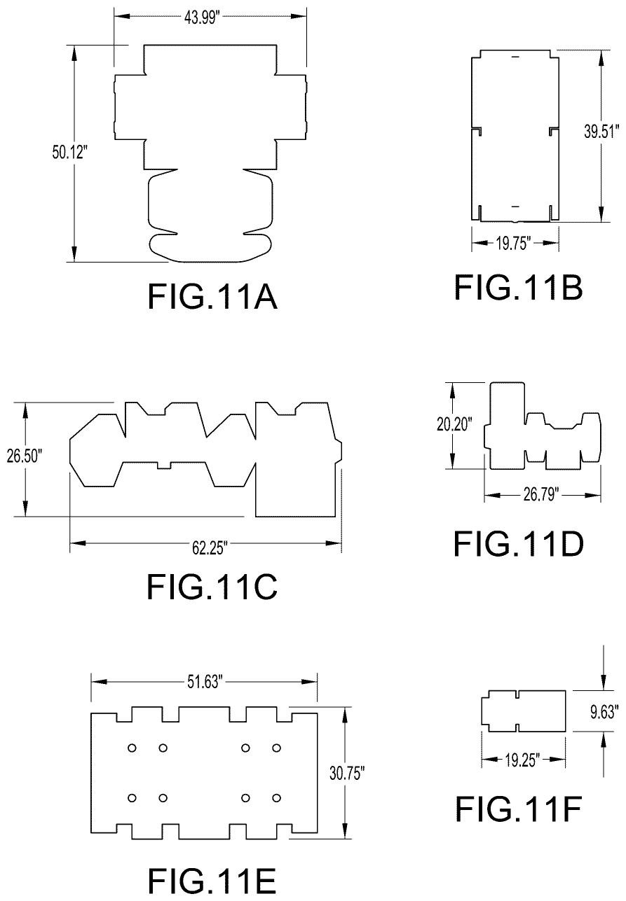

Instead of inputting sheet and bundle data manually, this information can be obtained from a CAD file containing a description of the sheets and the stacks. Examples of outlines of sheets that can be formed into stacks and modeled and processed by aspects of the present disclosure are shown in FIGS. 11A-11F.

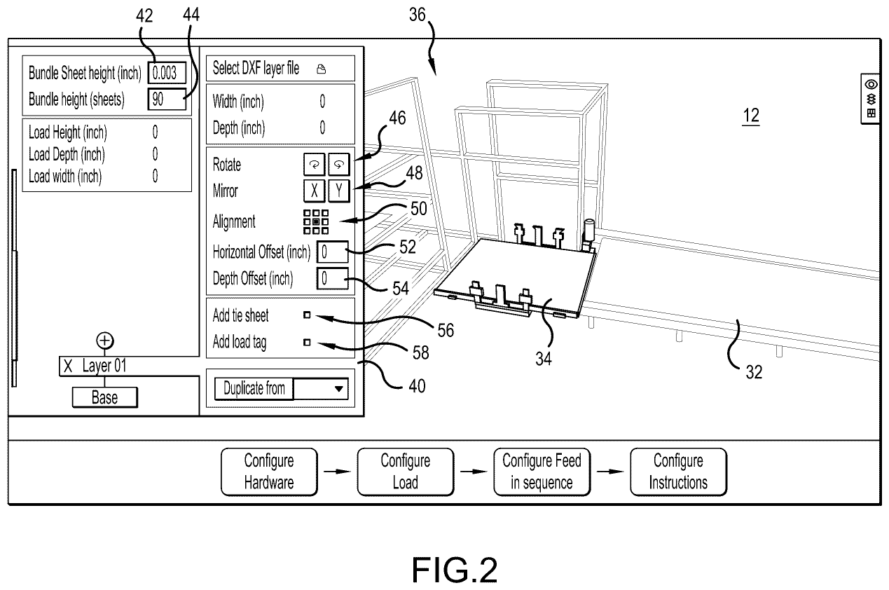

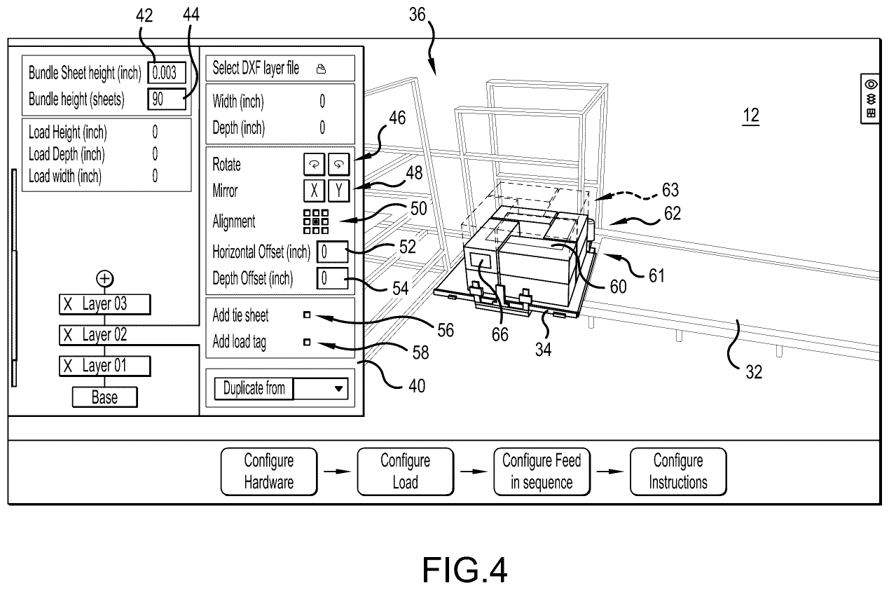

FIG. 2 shows an expanded version of the menu 40 and depicts virtual buttons 46 that allow a user to rotate bundles B clockwise and counterclockwise and virtual buttons 48 that allow a user to mirror an already-displayed bundle B. Bundle alignment can be defined in area 50 of the menu 40, horizontal offset can be input in field 52, depth offset can be input in field 54, a tie sheet can be added by checking box 56 and a load tag can be added by checking box 58. A tie sheet 60 and a load tag 62 are shown in FIG. 4.

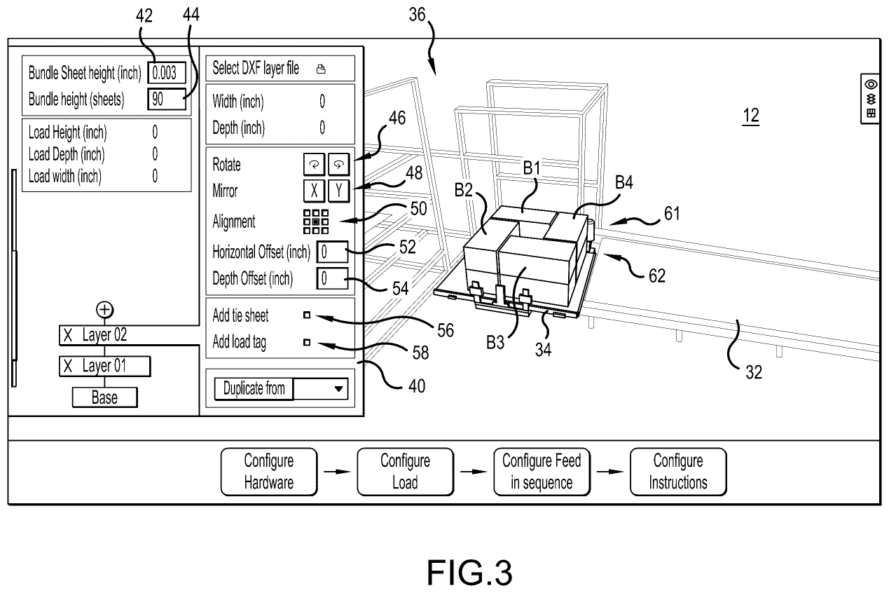

FIG. 3 shows an example of two layers L1, L2 of four bundles B1, B2, B3, B4 each arranged on the staging platform 34 on a footprint that corresponds to the dimensions of the pallet that will support the finished stack of bundles B. The position and orientation of each bundle B1, B2, B3, B4 in each layer L1, L2 of the stack can be defined and changed by the user, and this process is repeated for as many unique layers as needed to accurately define the stack.

FIG. 4 shows, by way of the dashed-line image of a third layer L3 of bundles B, that a user can also edit lower layers of the stack, such as layer L2, even after additional layers like layer L3 have been added above the lower layer.

After the dimensions and footprint of a desired stack are defined, the microprocessor 22 of the computer system 10 running the conveyor model 16 and using the bundle model 18 calculates how the conveyor system 14 should operate to create the desired stack footprint on the staging support 34. The computer conveyor model 16 models the various sections of the conveyor system 14 and allows movement of various bundles B along the conveyor system 14 to be visualized and modified before creating a control data set that can be output to the controller 24 of the physical conveyor system 14 to cause the physical conveyor system 14 to perform the required operations to create the desired footprint based on the configuration of bundles arriving at the input location 26.

The computer conveyor model 16 assumes a known lateral location and angular orientation of each of the bundles B at a given location on the conveyor 14 for use in determining how to move and orient the bundles B to produce the stack footprint. For example, the conveyor model 16 may assume that each bundle B will always exit the corner table 30 with its length axis perpendicular to the downstream direction and its width axis precisely aligned with the centerline of the intermediate conveyor section 29. To account for positioning errors that may arise, the conveyor system 14 may include one or more sensors (e.g., optical sensors or 2- or 3-dimensional sensors) 70 (FIG. 6) for sensing an actual position and orientation of the bundles B and providing this information to the conveyor controller 24. Then, if the control data set contains instructions to, e.g., shift a bundle six inches in one direction and the sensor output indicates that the width axis of the bundle B is located 0.5 inches out of position in the opposite direction, the conveyor controller 24 can cause the bundle B to be shifted 6.5 inches in the one direction to correct for the initial positional error. Alternately, data from a sensor 70 can be used to control the corner table 30 such that it always outputs a bundle B at a specific location and in a given orientation. That is, the corner table 30 may perform rotating and shifting function in addition to changing a direction of movement of a bundle.

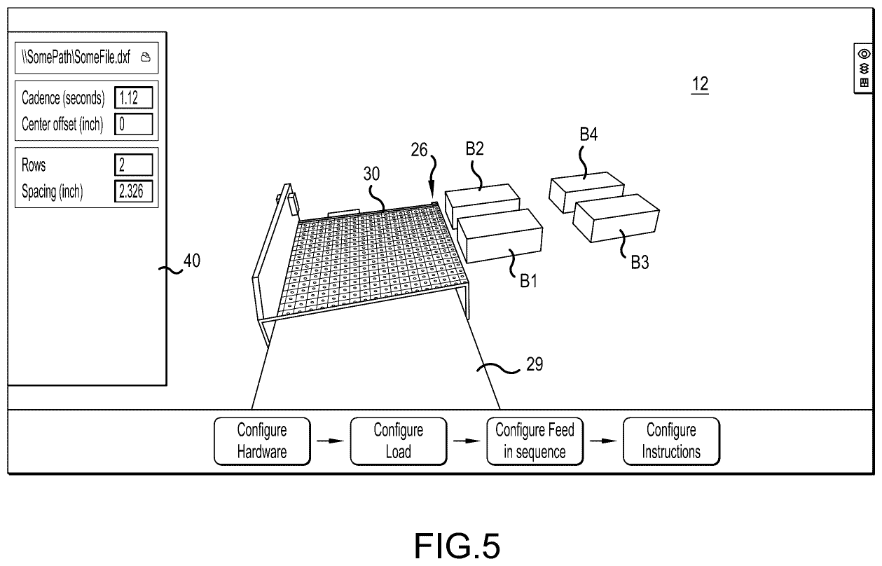

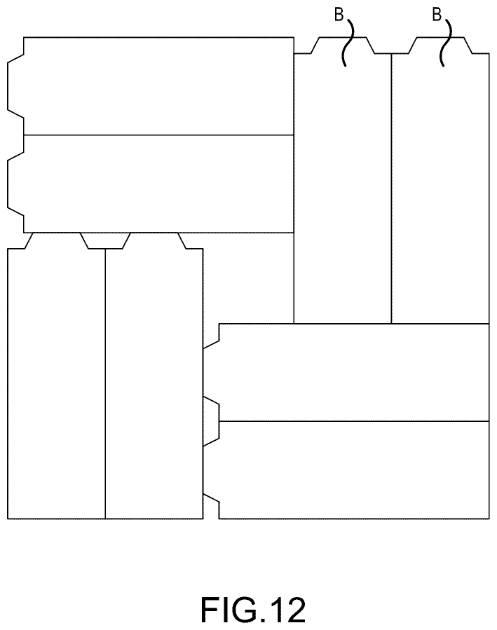

FIG. 5 shows that bundles B1, B2, B3, B4 can arrive at the corner conveyor 30 in pairs. This may be an efficient way to process bundles for some stack footprints. For example, if each layer of a stack of bundles B will include four pairs of bundles B as illustrated, for example, in FIG. 12, the bundles can be moved two at a time. On the other hand, as shown in FIG. 6, bundles B1, B2, B3, B4 may arrive at the corner conveyor 50 in series, especially for forming layer configurations in which each of the adjacent bundles B have different orientations.

Referring now to FIG. 6, with the shape and size of the incoming bundles B1, B2, B3, B4 having been defined, the sequencing of the bundles B1, B2, B3, B4 into the formed layer is defined for each layer. Color coding and/or other numbering methods can be used to simplify and facilitate interpretation of this process for the setup technician. That is, each of the bundles B1, B2, B3, B4 can be depicted in a different color in the display 12 although in the present disclosure they are merely identified by the letter “B” and a number.

An algorithm for producing the layer of four bundles B1, B2, B3 and B4 shown in FIG. 6 is described below in connection with FIG. 6. The layer pattern shown on the staging support 34 in FIG. 6 has been defined, either via the input of relevant CAD files or manually, and the computer system 10 uses the conveyor model 16 to determine how to rotate and/or shift each of the incoming bundles B1, B2, B3 and B4 in order to produce the desired layer pattern on the staging platform 34. The bundles B1, B2, B3 and B4 are shown in their starting and ending positions in FIG. 6; that is, bundle B1 approaching the corner conveyor 30 is the same bundle B1 on the staging platform 34 after it has been suitably rotated and translated by the rotating conveyor section 31 and the shifting conveyor section 32.

The computer system 10 first determines which of the bundles B will be located at a position furthest downstream from the corner conveyor 30. When, as in the present case, the downstream-most edges of two bundles (B1 and B2) are equidistant from the corner conveyor 30, either of bundles B1, B2 may be selected as the first bundle to be processed, either randomly or using the appropriate metric such as the bundle having the longest or shortest side edge located at the greatest downstream distance from the corner conveyor 30. In FIG. 6, both bundles B1 and B2 will have an edge located an equal distance from the corner conveyor 30. In this embodiment, the system selects the bundle having the shortest downstream-most edge, in this case bundle B1, for initial processing.

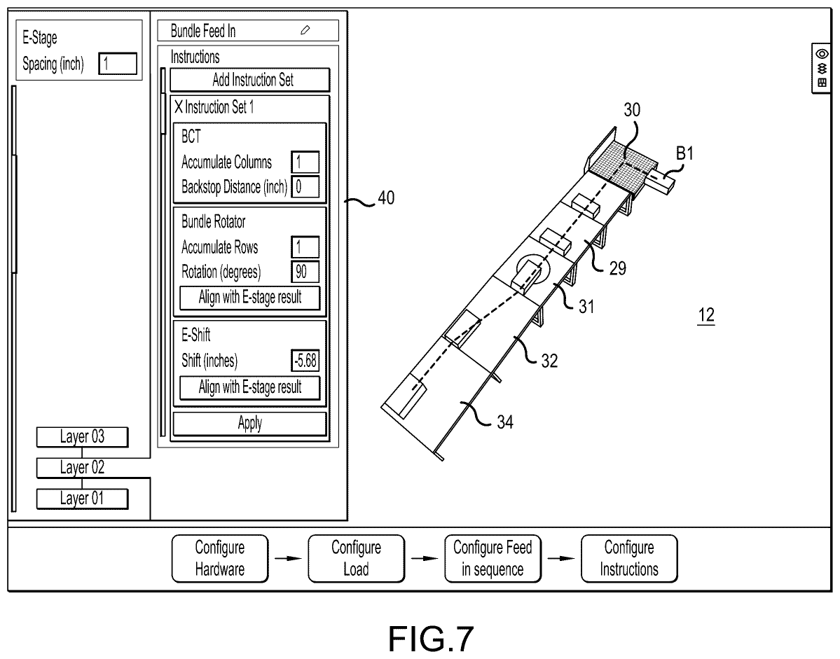

By comparing the location of the bundle B1 leaving the corner conveyor 30 with a required end location on the downstream staging support 34, the computer system 10 determines that the bundle B1 must be rotated 90 degrees and then shifted to the right (from the point of view of the bundle B1) at some point between the corner conveyor 30 and the downstream staging support 34. Therefore, as shown in FIG. 7, the intermediate conveyor section 29 carries the bundle B1 to the rotating conveyor section 31 which rotates the bundle 90 degrees and moves it onto the shifting conveyor section 32. The shifting conveyor 32 is then controlled to move the bundle B1 to a location close to the right edge of the shifting conveyor 32 and from the shifting conveyor 32 onto the staging support 34. This location may be defined, for example, by a gate or a physical structure (not illustrated) extending across the staging support 34 to prevent further downstream movement of the bundle B1 past the staging support 34 even if the staging support 34, which may comprise a conveyor, continues to move.

It is noted that while the disclosed embodiment uses a separate rotating conveyor section 31 and shifting conveyor section 32, conveyor sections exist that can both a rotate and shift a bundle. Furthermore, the corner conveyor section could alternately be configured to perform a rotating and/or shifting operation to ensure that every bundle enters the intermediate conveyor section in a desired orientation and a desired position relative to a centerline of the intermediate conveyor section 29.

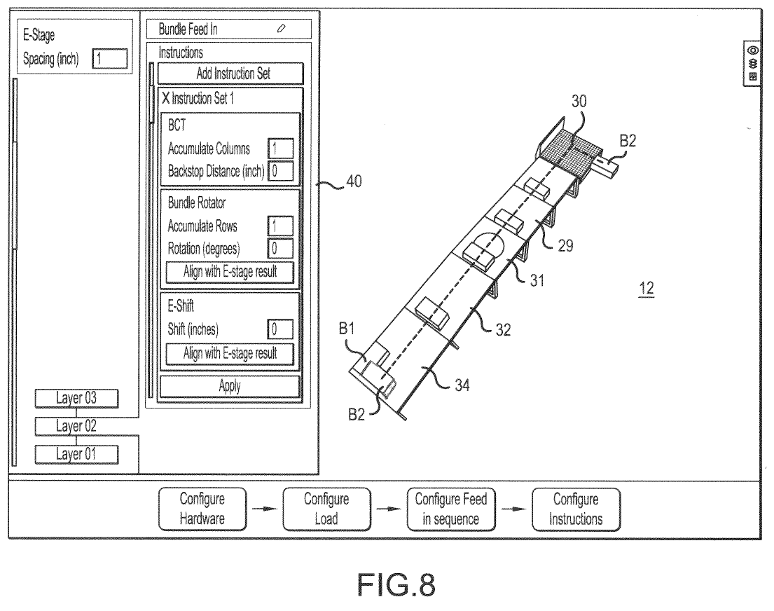

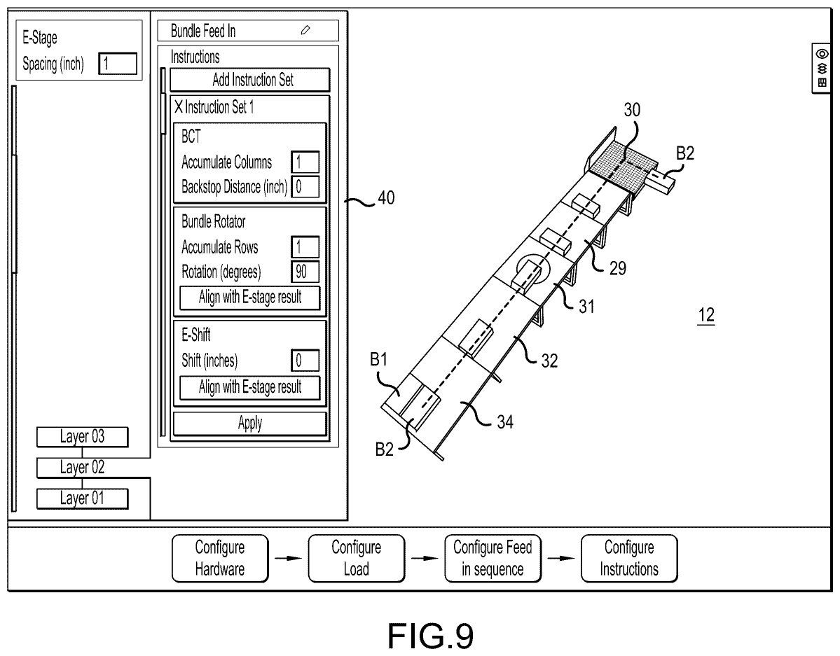

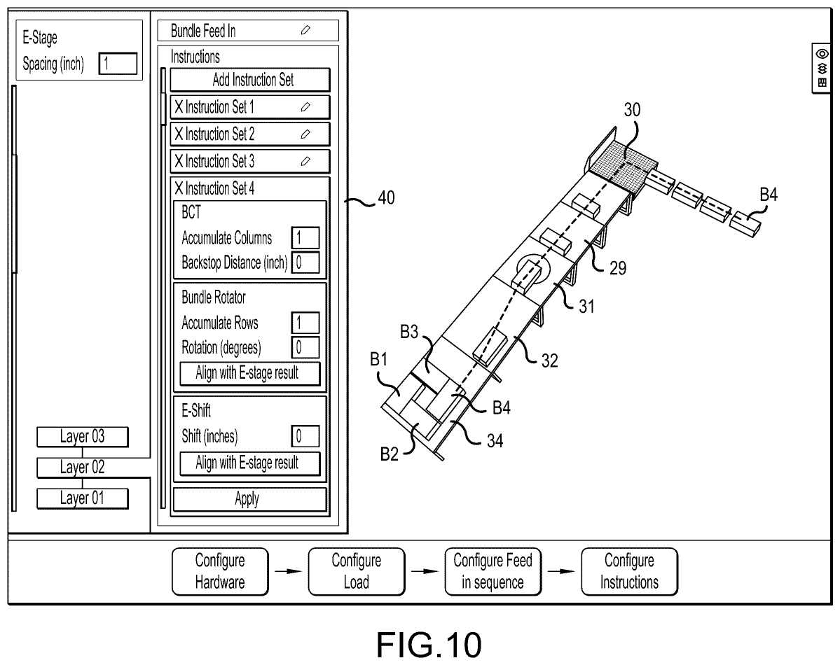

The computer system 10 next determines how the second bundle, bundle B2, must be moved to reach the required location in the previously determined stack footprint on the staging support 34. It can been seen from FIG. 8 that if the second bundle B2 is moved directly toward the staging support 34 without being rotated or shifted it will collide with the first bundle B1 already in place on the staging support 34. However, as shown in FIG. 9, if the second bundle B2 is rotated 90 degrees by the rotating conveyor section 31 and possibly shifted slightly to the left by the shifting conveyor section 32, it will avoid colliding with the first bundle B1. Of course, because the desired final orientation of the bundle B2 requires a 90 degree shift from the orientation of the bundle B1 on the staging support 34, the bundle B2 should merely be shifted to the left so that it arrives at the location shown in FIG. 6 and FIG. 10. Similar calculations are made for the third and fourth bundles B3 and B4 to form the finished stack footprint shown in FIG. 6, and the rotation and lateral movement of the fourth bundle B4 is illustrated in FIG. 10. The data set produced by the computer system 10 can then be output to the controller 24 of the conveyor system 14 to cause the conveyor system 14 to perform the actions required to produce a desired pattern of bundles on the staging support 34.

Importantly, a predefined gap at least in the lateral direction should be maintained so that slight inaccuracies in positioning do not cause the bundles to interfere with each other when they reach the staging support 34. Thus once the bundle dimensions are known from a CAD file and the locations of the bundles relative to the rotating conveyor 31 when they arrive at the rotating conveyor 31 are known and the desired final bundle pattern is known, the computer system 10 calculates a required lateral shift and/or rotation for each of the bundles B1, B2, B3, B4 as they travel toward the staging support 34. For example, the lateral shift may be 0.25 inches more than what is required to avoid a direct collision between two of the bundles B.

An animated display of the bundles B as they move may also allow a user to confirm that the movements determined by the computer system 10 will result in the desired bundle pattern and allow the user to make any changes that might be suggested by the animation. For example, based on the shape of each bundle, the user may determine that the lateral spacing between bundles should be increased for a particular product run.

Finally, in order to form certain bundle patterns, such as the “double chimney” configuration shown in FIG. 12, mentioned above, it may be desirable to move multiple bundles through the system together. That is, if the desired bundle pattern on the staging support 34 comprises two adjacent bundles B1, B2 having their length axes parallel to the downstream direction, the bundles B1, B2 may arrive at the corner conveyor 30 in pairs, be rotated together as a pair by the rotating conveyor section 31, shifted toward each other by the lateral shifting conveyor 32 and moved together onto the staging support 34 in this configuration. Similarly, if the length axes of a pair of bundles B1, B2 is perpendicular to the downstream direction, the bundles B1, B2 may be moved together as a pair without being rotated by the rotating conveyor section 31. The computer system 10 will identify final layer patterns that are amenable such movement of bundles in pairs (or in threes or fours) and proceed to move those bundles in pairs, etc., to improve system throughput.

In some embodiments, the lateral shifting conveyor 34 may not be configured to move a pair of bundles independently (toward or away from each other) in order to change a spacing therebetween. In that case, when the bundles B arrive at the corner conveyor 30 with their length axes perpendicular to the downstream direction, the corner conveyor 30 can be operated at a higher speed than the intermediate conveyor section 29 so that the trailing one of the pair of bundles B is moved against the leading one of the pair of bundles B to remove the space therebetween. If the pair of bundles B1, B2 arrive at the corner conveyor 30 with their length axes parallel to the downstream direction, the corner conveyor 30 can be operated at a lower speed that the conveyor (not illustrated) immediately upstream from the corner conveyor 30 so that the trailing one of the bundles B is moved into contact with the leading one of the bundles B to remove the space therebetween and allow the bundles to be processed together as a pair.

The higher level control system can predict the rotation required (usually +90°, −90°, or) 180° needed to properly orient a particular bundle for the desired layer. This prediction can then be confirmed by the user. That is, the system may present the user with proposals for rotating and/or shifting bundles in order to arrive at a previously defined final layer pattern. The user can confirm these predictions and/or modify the suggested movements to, for example, provide a greater degree of spacing between the bundles on staging support 34.

Once a layer is complete, a 3D simulation (digital twin) of the actual bundle motions can be viewed in real-time (or at an alternate time scale). This confirms correct operation prior to running actual product. Any incorrect processes or interferences are identified in advance by the simulation.

Once the formation of each layer has been confirmed, the full stack process can be viewed as a 3D simulation and confirmed. In addition to verifying physical orientations and fits, an accurate estimate of cycle time can be computed.

The simulation data can then be compared to actual data for machine performance reported by the conveyor controller 24 (e.g., a PLC) to anticipate machine problems and failures. All machinery and products (bundles) in the simulation are defined at 1:1 scale so real-world values are then sent as instruction sets to the conveyor controller 24 to process as actual movements of the equipment. This process is very similar to G-code technology used on CNC equipment.

These data sets can also be stored for future recall when the particular product is manufactured at a later time. Recall and subsequent simulation of a particular product also allow for visualization and confirmation of the production process without having to actually set up and manufacture the product.

The present invention has been described above in connection with a presently preferred embodiment thereof. Additions and modifications to the disclosed embodiment will become apparent to persons of ordinary skill in the art upon a reading of the foregoing disclosure. It is intended that all such additions and modifications form a part of the present invention to the extent they fall within the scope of the several claims appended hereto.

What is claimed is:

1. A method comprising:
defining a configuration of a given number of physical bundles on a physical support surface;
providing a bundle computer model of at least one of the given number of physical bundles;
providing a conveyor computer model of a physical conveyor, the physical conveyor being configured to carry the physical bundles one or more at a time from an upstream end of the physical conveyor to a downstream end of the physical conveyor and to deposit the physical bundles on the physical support surface, the physical conveyor including a controller and at least one adjustment section configured to adjust a position and/or orientation of the physical bundles; and
using a processor running the conveyor computer model to automatically determine from the conveyor computer model and the bundle computer model a control data set including instructions for causing the controller to operate the physical conveyor to produce the configuration of the given number of the physical bundles on the physical support surface.

2. The method according to claim 1,
wherein the at least one adjustment section includes a rotating conveyor section configured to adjust an orientation of the physical bundles and a shifting conveyor section configured to shift the physical bundles in a direction transverse to a downstream direction.

3. The method according to claim 2,
wherein the conveyor computer model includes a starting position and a starting orientation for each of the bundles arriving at the upstream end of the physical conveyor.

4. The method according to claim 2,
including at least one sensor configured to sense the orientation of the physical bundles at the rotating conveyor section and/or to sense a location of the physical bundles at the shifting conveyor section,
wherein the at least one sensor is configured to communicate the orientation of the physical bundles and/or the location of the physical bundles to the controller of the physical conveyor.

5. The method according to claim 2,
including communicating the control data set to the controller of the physical conveyor, and
operating the physical conveyor based on the control data set to produce the configuration of the given number of physical bundles on the physical support surface.

6. The method according to claim 1,
wherein each of the physical bundles includes a number of individual sheets, and
wherein the desired configuration of the given number of physical bundles includes a footprint of a stack of bundles and a height of the stack of bundles.

7. The method according to claim 1,
wherein the bundle computer model comprises a CAD description of at least one of the physical bundles.

8. The method according to claim 1,
wherein the defining the configuration comprises receiving a user input regarding a desired position and/or a desired orientation of at least one of the physical bundles.

9. The method according to claim 1,
wherein the control data set defines a position and an orientation of each of the plurality of bundles at multiple locations between the upstream end of the physical conveyor and the physical support surface.

10. The method according to claim 5,
wherein the instructions for causing the controller to operate the physical conveyor include instructions to operate the physical conveyor in a manner that moves groups of the bundles in parallel along the physical conveyor.

11. The method according to claim 1,
wherein the physical conveyor includes a corner table upstream from the adjustment section configured to receive bundles from an entrance conveyor and rotate and/or shift the physical bundles to produce the starting position and starting orientation for each of the bundles.

12. A non-volatile computer-readable medium storing instruction that when executed by a computer processor causes the computer processor to execute a method according to claim 1.

13. A device including a computer processor configured to:
store a definition of a configuration of a given number of physical bundles on a physical support surface;
store a bundle computer model of each of the given number of physical bundles;
store a conveyor computer model of a physical conveyor, the physical conveyor being configured to carry the given number of physical bundles from an upstream end of the physical conveyor to a downstream end of the physical conveyor and to deposit the physical bundles on the physical support surface, the physical conveyor including a controller and at least one adjustment section configured to adjust a position and/or orientation of the physical bundles; and
use the conveyor computer model to automatically determine from the conveyor computer model and the bundle computer model a control data set including instructions for causing the controller to operate the physical conveyor to produce the configuration of the given number of the physical bundles on the physical support surface.

14. A system comprising:
a device according to claim 13, and
the physical conveyor,
wherein the controller of the physical conveyor is configured to receive the control data set from the processor and control an operation of the physical conveyor to produce the configuration of the given number of physical bundles on the physical support surface.

15. The system according to claim 14,
wherein the at least one adjustment section includes a rotating conveyor section configured to adjust an orientation of the physical bundles and a shifting conveyor section configured to shift the physical bundles in a direction transverse to a downstream direction,
wherein the system includes at least one sensor configured to sense the orientation of the physical bundles at the rotating conveyor section and/or configured to sense a location of the physical bundles at the shifting conveyor section, and
wherein the at least one sensor is configured to communicate the orientation of the physical bundles and/or the location of the physical bundles to the controller of the physical conveyor.
